(19) United States
(12) Patent Application Publication
(10) Pub. No.: US 2025/0385471 A1
(43) Pub. Date: Dec. 18, 2025

(54) Plug-In Connector Having A Two-Part Identifying Feature

(71) Applicant: HIRSCHMANN AUTOMOTIVE GMBH, Rankweil/Brederis (AT)

(72) Inventors: Ümit BAS, Sulz (AT); Luis GAPP, Hergensweiler (DE)

(21) Appl. No.: 18/833,338

(22) PCT Filed: Feb. 7, 2023
(86) PCT No.: PCT/EP2023/052930

§ 371 Date: Feb. 27, 2025

(30) Foreign Application Priority Data
Feb. 9, 2022 (DE) 10 2022 103 035.0

(51) Int. Cl. H01R 13/641

(52) U.S. Cl. CPC H01R 13/641

(57) ABSTRACT

Plug-in connector, having at least two components and having an identifying feature, in particular a machine-readable code, the identifying feature is split into at least two parts, wherein one part is arranged on one component of the plug-in connector and the at least one further part is arranged on the further component of the plug-in connector, wherein these preferably two components are movable relative to one another between a first and at least one further, in particular a second, functional position, wherein the preferably two parts of the identifying feature are offset or spaced apart from each other in the first functional position and put together in one plane without an offset or without a spacing in the second functional position.

The invention relates to a plug-in connector having at least two components with an identification feature, in particular a machine-readable code.

From EP 3 381 091 B1, a plug-in connector is known which has at least two components (such as in particular a housing and a part movable relative thereto, such as a lever or a contact protection element or the like), which has an identification feature, in particular a machine-readable code. In this regard, means are provided which ensure that in one functional position of the plug-in connector (such as not yet plugged into a mating plug-in connector or the lever or contact protection element not yet fully actuated) the identification feature is not recognizable (concealed), whereas in another functional position of the plug-in connector (such as plugged into a mating plug-in connector or the lever or contact protection element being fully actuated) the identification feature is visible and can optionally be evaluated.

The invention is based on the object of providing an improved plug-in connector compared to this prior art, which is reduced in particular with regard to its design complexity while at the same time ensuring that the identification feature reliably represents the at least two functional positions.

This object is achieved in that the identification feature is divided into at least two, preferably exactly two parts, wherein the one part is arranged on the one component of the plug-in connector, and the at least one further part is arranged on the further component (and optionally a third part of the identification feature on a third component of the plug-in connector and so on) of the plug-in connector, wherein these preferably two components are movable relative to one another between a first and at least one further, in particular a second, functional position, wherein the preferably two parts of the identifying feature are offset or spaced apart from each other in the first functional position and put together in one plane without an offset or without a spacing in the second functional position. Advantageously, no additional means are required that conceal or reveal the identifying feature. Only those components of the plug-in connector that are moved relative to each other in one way or another are used to realize the identification feature in an unevaluable, in particular unreadable (in the first functional position) or evaluable, in particular readable (in the second functional position) manner.

The first component of the plug-in connector is preferably its housing, within which at least one contact is mounted, optionally arranged in a contact carrier. The second component of the plug-in connector can be, for example, a lever of a pull-in aid, a contact protection element (also called CPA) or another component which is movable between a first and a second position relative to the first component, in particular the housing, of the plug-in connector.

A plug connection, for example, consists of a plug-in connector that is plugged together with a mating plug-in connector. According to the invention, the identification feature is arranged only on the plug-in connector or only on the mating plug-in connector, or a separate identification feature is arranged on both the plug-in connector and the mating plug-in connector. Alternatively, it is conceivable to arrange at least one part, preferably a first half, of the identification feature on the plug-in connector and at least one further part, preferably the second half, of the identification feature on the mating plug-in connector. If the plug-in connector is not yet plugged together, the respective parts of the identification feature are at a distance from each other so that it cannot be read or evaluated. Only when the plug-in connector and mating plug-in connector are plugged together to form the plug connection can the fully assembled identification feature be read or evaluated. The same also applies alternatively to the plug-in connector/cable arrangement (one part of the identification feature on the plug-in connector and the other part on the cable).

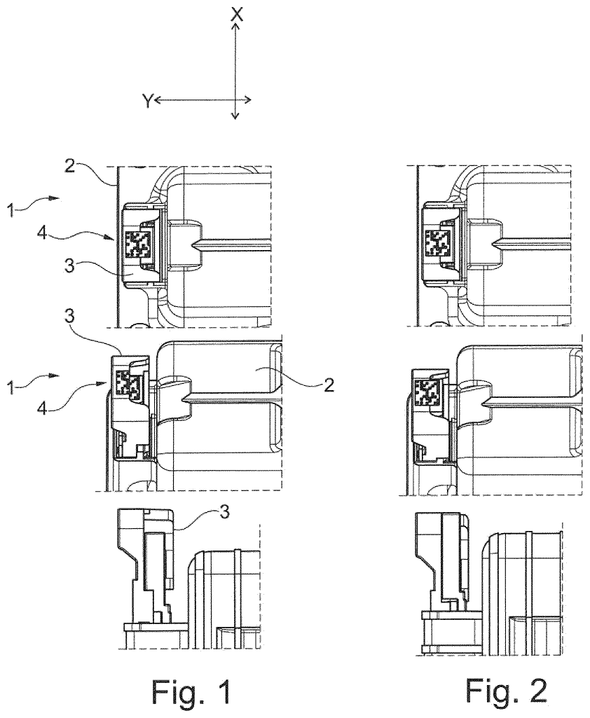

An embodiment according to the invention is shown in FIGS. 1 to 6.

FIG. 1 (particularly clearly visible in the middle illustration), 3 (also particularly clearly visible in the lower illustration) and 5 show an identification feature which is not readable or cannot be evaluated, in particular is not readable for a sensor. This identification feature is preferably a Data Matrix Code (DMC). The identification feature is therefore not legible or cannot be evaluated because the surfaces of the two components, on each of which a part of the identification feature is arranged, are offset from one another, in particular at a different height. In the embodiment shown in FIGS. 1, 3 and 5, one component is a housing of the plug-in connector and the second component is a locking element (also called CPA), which are arranged offset relative to one another, in particular offset in height. The height difference is, for example, 5 mm (when looking at FIG. 1, lower illustration in the X direction). The offset or height difference can also be larger or smaller than the shown 5 mm, for example. In addition, the offset or a distance of the two components from each other can also be in another direction, such as in the Y or Z direction.

FIGS. 2, 4 and 6 show the identification feature which is readable or evaluable, in particular readable by a sensor. This identification feature is now readable or evaluable because the surfaces of the two components, on each of which a part of the identification feature is arranged, are no longer offset in height or no longer arranged at a distance from one another, but are aligned in direct proximity to one another, preferably in the same plane or in almost the same plane without any significant offset in height.

FIG. 1 shows different views of a plug-in connector 1. The top view shows the plug-in connector from above, the middle view obliquely from the side, and the bottom view from the side.

The plug-in connector 1 has a housing 2 as a first component, wherein a contact protection element 3 is provided as a further component 3 relative to the housing 2. The contact protection element 3 is movable between two positions relative to the housing 2. The contact protection element 3 is in the first position (here a pre-locking position) when the plug-in connector 1 is not yet plugged into a mating plug-in connector (not shown). In this case, a surface of the housing 2 and a surface of the contact protection element 3 are offset, in particular offset in height, or spaced apart (depending on the point of view) from one another, wherein a part of an identification feature 4 is applied to each of the preferably two surfaces. In this case, the identification feature 4 is a data matrix code (DMC, also known as QR code). However, it can also be another suitable identifying feature. In this embodiment, the identification feature 4 is arranged in two halves, on the one hand on the housing 2 and the on the other hand on the contact protection element 3. However, other divisions of the identifying feature 4 are also conceivable.

In particular with regard to the middle illustration in FIG. 2, it can be seen that the two halves of the identification feature 4 in the first position of the contact protection element 3 are offset from one another in relation to the housing 2 of the plug-in connector 1, in particular in the X direction. Not only in this embodiment, but also in general, it can be considered to design the offset or the distance between the preferably two parts of the identification feature 4 not or not only in the X direction, but also in the Y direction and/or also in the Z direction. If, for example, the two parts of the identification feature 4 are designed in the Y direction in relation to each other, there is no height offset, but the two parts are arranged at a distance from each other.

In the various illustrations in FIG. 2, which correspond to the various illustrations in FIG. 1, it is shown that the second component, in particular the contact protection element 3, has been actuated. This is possible in this embodiment when the plug-in connector 1 has been properly plugged together with a mating plug-in connector (not shown). This relative movement of the contact protection element 3 in relation to the housing 2 (here a downward pressure) causes the two parts, in particular the two halves, of the identification feature 4 to be arranged at the same height, i.e. in one plane, directly next to one another (with no or no significant distance) so that the identification feature 4 is readable, in particular can be evaluable by a sensor. If the identification feature 4 is the displayed data matrix code, a slight offset of the two parts of the identification feature 4, in particular a displayed height difference, or even a slight gap in the Y and/or Z direction can be permitted without impairing the readability or evaluability.

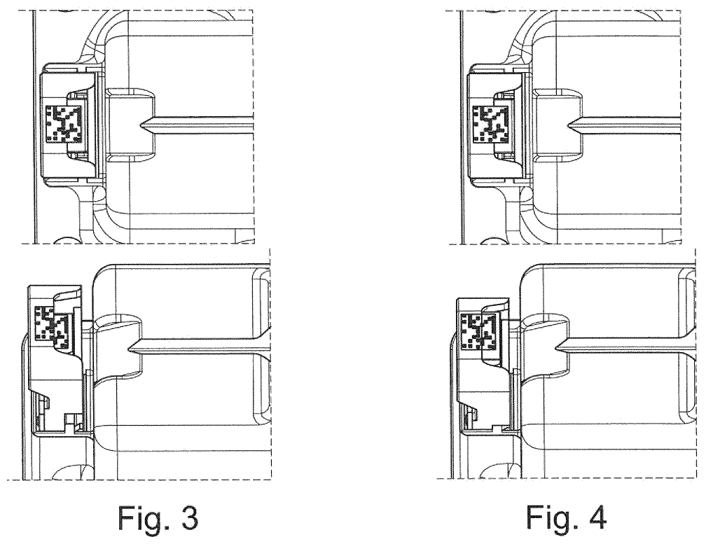

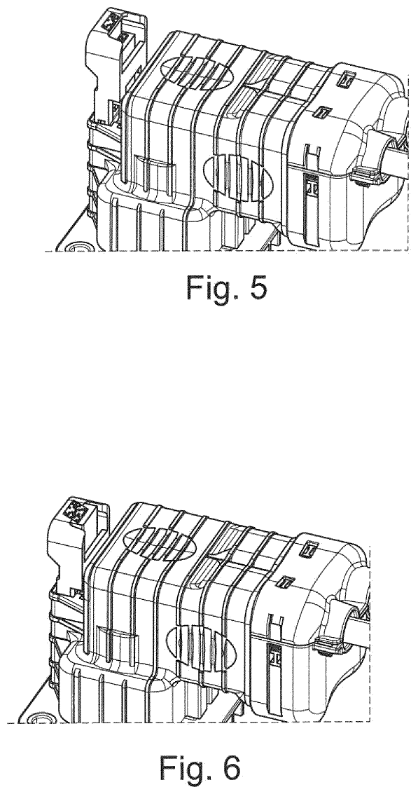

In FIGS. 3 and 5, analogous to the different views as shown in FIG. 1, the first functional position (pre-locking position) of the contact protection element 3 in relation to the housing 2 of the plug-in connector is shown before the actuation of contact protection element 3.

The same applies to FIGS. 4 and 6 in which the second functional position (final locking position) of the contact protection element 3 in relation to the housing 2 of the plug-in connector 1 is shown after the actuation of the contact protection element 3.

The identification feature 4 is chosen depending on its function. It can, for example, be a separate component (such as a film or the like), the parts of which are on the one hand applied to the first component (in particular the housing 2) and the second component (in particular the contact protection element 3) of the plug-in connector 1. Alternatively, it is conceivable that the two parts, preferably the two halves, of the identification feature 4, in particular of the data matrix code, are applied to the two components of the plug-in connector 1 with a laser. It is conceivable to use an individually recognizable identification feature 4 for each individual plug-in connector. Alternatively, it can also be considered to use the same identification feature 4 for a large number of plug-in connectors 1, in particular plug-in connectors of the same design.

The dimensions (such as 0.5 mm or 5 mm) are only examples and can vary upwards or downwards depending on the function or size of the plug-in connector and its components or the readout and/or evaluation unit and its readout or evaluation process.

1.-5. (canceled)

6. A plug-in connector, having at least two components and having an identifying feature, in particular a machine-readable code, wherein the identifying feature is split into at least two parts, wherein one part is arranged on the one component of the plug-in connector and the at least one further part is arranged on the further component of the plug-in connector, wherein these preferably two components are movable relative to one another between a first and at least one further, in particular a second, functional position, wherein the preferably two parts of the identifying feature are offset or spaced apart from each other in the first functional position and put together in one plane without an offset or without a spacing in the second functional position.

7. The plug-in connector according to claim 6, wherein the identification feature is divided into exactly two parts.

8. The plug-in connector according to claim 6, wherein at least a third part of the identification feature is arranged on a third component of the plug-in connector (and so on) of the plug-in connector.

9. The plug-in connector according to claim 6, wherein the component is a housing of the plug-in connector and a part movable relative thereto, such as a lever or a contact protection element or the like.

10. The plug-in connector according to claim 6, wherein the identification feature is a machine-readable data matrix code.
